(19) United States
(12) Patent Application Publication
(10) Pub. No.: US 2014/0356636 A1
(43) Pub. Date: Dec. 4, 2014

(54) SOLUTION OF AROMATIC POLYAMIDE FOR PRODUCING DISPLAY ELEMENT, OPTICAL ELEMENT, OR ILLUMINATION ELEMENT

(71) Applicants: Akron Polymer Systems, Inc., Akron, OH (US); Sumitomo Bakelite Co., Ltd., Shinagawa-ku (JP)

(72) Inventors: Limin SUN, Copley, OH (US); Jiaokai JING, Uniontown, OH (US); Dong ZHANG, Uniontown, OH (US); Frank W. HARRIS, Boca Raton, FL (US); Hideo UMEDA, Kobe-shi (JP); Ritsuya KAWASAKI, Kobe-shi (JP); Toshihiko KATAYAMA, Kobe-shi (JP); Yusuke INOUE, Kobe-shi (JP); Jun OKADA, Kobe-shi (JP); Mizuho INOUE, Kobe-shi (JP); Manabu NAITO, Kobe-shi (JP)

(73) Assignees: Akron Polymer Systems, Inc., Akron, OH (US); Sumitomo Bakelite Co., Ltd., Shinagawa-ku (JP)

(21) Appl. No.: 14/288,729

(22) Filed: May 28, 2014

Related U.S. Application Data
(60) Provisional application No. 61/828,046, filed on May 28, 2013.

(51) Int. Cl. C08K 5/41; C08K 5/07; C08K 5/101; B05D 5/06; C08K 5/3415; C08K 5/1535; C08K 5/1545; C08K 5/1565; C08K 5/05; C08K 5/20

(52) U.S. Cl. CPC C08K 5/41; C08K 5/05; C08K 5/07; C08K 5/101; C08K 5/20; C08K 5/3415; C08K 5/1535; C08K 5/1545; C08K 5/1565; B05D 5/06
USPC 428/435; 524/379; 524/361; 524/323; 524/317; 524/233; 524/104; 524/173; 524/376; 524/111; 524/220; 524/99; 524/108; 427/162; 428/477.7; 428/446; 428/426

(57) ABSTRACT

This disclosure, in one or plurality of embodiments, relates to a solution of polyamide from which a cast film with low CTE and Rth can be achieved. This disclosure, viewed from one aspect, relates to a solution of polyamide comprising: an aromatic polyamide; inorganic filler; and a solvent. This disclosure, viewed from one aspect, relates to a laminated composite material, comprising a base, and a polyamide resin layer: wherein the polyamide resin layer is laminated to one surface of the base; and wherein the polyamide resin layer is obtained or obtainable by applying a polyamide solution comprising an aromatic polyamide, an inorganic filler and a solvent onto the base.

### CROSS REFERENCE TO RELATED APPLICATIONS

The disclosure is based upon and claims priorities from U.S. Provisional Application Ser. No. 61/828,046, the disclosures of which are hereby incorporated by reference herein in its entirety.

### TECHNICAL FIELD

This disclosure, in one aspect, relates to a solution of polyamide including an aromatic copolyamide and a solvent. This disclosure, in another aspect, relates to a process for manufacturing the polyamide solution. This disclosure, in another aspect, relates to a laminated composite material for producing a display element, optical element, or illumination element. This disclosure, in another aspect, relates to a process for manufacturing a display element, an optical element or an illumination element, including a step of forming a polyamide film using the polyamide solution.

### BACKGROUND ART

As transparency is required of display elements, glass substrates using a glass plate have been used as substrates for the elements (JP10311987 (A)). However, for display elements using a glass substrate, problems such as being heavy in weight, breakable and unbendable have been pointed out at times. Thus, the use of a transparent resin film instead of a glass substrate has been proposed.

For example, polycarbonates, which have high transparency, are known as transparent resins for use in optical applications. However, their heat resistance and mechanical strength can be an issue when using them in manufacturing display elements. On the other hand, examples of heat resistant resins include polyimides. However, typical polyimides are brown-colored, and it can be an issue for use in optical applications. As polyimides with transparency, those having a ring structure are known. However, the problem with such polyimides is that they have poor heat resistance.

For polyamide films for use in optical applications, WO 2004/039863 and JP 2008-260266(A) each disclose an aromatic polyamide having a diamine including a trifluoro group, which offers both high stiffness and heat resistance.

WO 2012/129422 discloses a transparent polyamide film with thermal stability and dimension stability. This transparent film is manufactured by casting a solution of aromatic polyamide and curing the casted solution at a high temperature. The document discloses that the cured film has a transmittance of more than 80% over a range of 400 to 750 nm, a coefficient of thermal expansion (CTE) of less than 20 ppm/° C., and shows favorable solvent resistance. And the document discloses that the film can be used as a flexible substrate for a microelectronic device.

### SUMMARY

This disclosure, in one aspect, relates to a solution of polyamide including an aromatic polyamide, an inorganic filler and a solvent.

Further, this disclosure, in one aspect, relates to a process for manufacturing a solution of an aromatic polyamide, and the process includes the steps of a) dissolving at least one aromatic diamine in a solvent; b) reacting the at least one aromatic diamine with at least one aromatic dicarboxylic acid dichloride, wherein hydrochloric acid and a polyamide solution are generated; c) removing the free hydrochloric acid using a trapping reagent; and d) adding an inorganic filler.

Further, this disclosure, in one aspect, relates to a laminated composite material including a base and a polyamide resin layer, wherein the polyamide resin layer is laminated on one surface of the base, and the polyamide resin layer is obtained or obtainable by applying a polyamide solution including an aromatic polyamide, an inorganic filler and a solvent onto the base.

Furthermore, this disclosure, in one aspect, relates to a process for manufacturing a display element, an optical element or an illumination element, and the process includes the steps of a) applying a solution of an aromatic polyamide onto a base to form a film; and b) forming the display element, the optical element or the illumination element on one surface of the polyamide film, wherein the solution of an aromatic polyamide includes an aromatic polyamide, a solvent, and an inorganic filler, and the base or the surface of the base is composed of glass or silicon wafer.

### BRIEF DESCRIPTION OF THE DRAWINGS

FIG. 1 is a schematic cross-sectional view showing a configuration of an organic EL element 1 according to one embodiment.

FIG. 2 is a flow chart for explaining a process for manufacturing an OLED element according to one embodiment.

### DETAILED DESCRIPTION

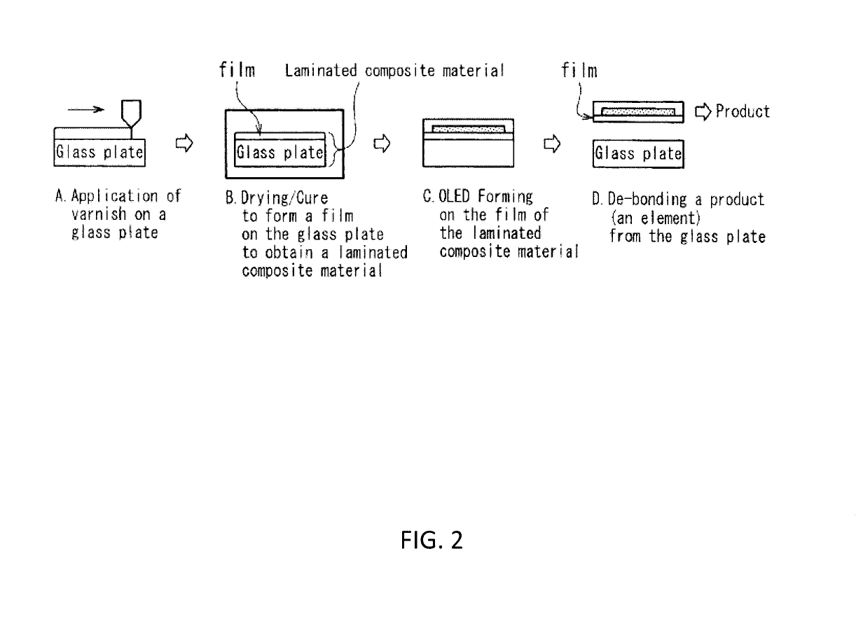

A display element, an optical element, or an illumination element such as an organic electro-luminescence (OEL) or organic light-emitting diode (OLED) is often produced by the process described in FIG. 2. Briefly, a polymer solution (varnish) is applied or casted onto a glass plate base or a silicon wafer base (step A), the applied polymer solution is cured to form a film (step B), an element such as OLED is formed on the film (step C), and then, the element such as OLED (product) is de-bonded from the base (step D). These days, polyamide film as well as polyimide film is used as the film in the process in FIG. 2.

Polyamide and polyimide films formed on glass bases in the step B of the process for manufacturing a display element, an optical element, or an illumination element described in FIG. 2 are organic, so that they tend to have a higher coefficient of thermal expansion (CTE) than inorganic materials. However, a higher coefficient of thermal expansion can result in the following problem. That is, the difference in coefficient of thermal expansion between the film and the base made of an inorganic material such as glass increases, thereby causing warpage of a laminated composite material including the film and the base. As a result, declines in the quality and yield occur. Attempts have been made to reduce the coefficient of thermal expansion by, for example, introducing a rigid structure in polyamide and drawing. The coefficient of thermal expansion can be reduced by such methods but the retardation in film thickness direction (Rth) increases as a result. An increase in Rth may cause adverse effects on the picture quality of a display, for example, a decline in the angle of view of a liquid crystal display.

That is, in a polyamide film, there are tradeoffs between the coefficient of thermal expansion (CTE) of the film and retardation (Rth) in the film thickness direction. However, it is desired that the both CTE and Rth are adjusted to a small level. With regard to these problems, it was found that by using a solution of polyamide containing an inorganic filler both the retardation in film thickness direction (Rth) and the coefficient of thermal expansion (CTE) of a cast film formed on a base made of an inorganic material such as glass could be reduced.

Therefore, the solution of polyamide according to this disclosure includes an aromatic polyamide and a solvent, and further includes an inorganic filler.

In one or plurality of embodiments, this disclosure relates to a solution of polyamide from which a cast film with low CTE and Rth can be achieved.

[Inorganic Filler]

In one or plurality of embodiments, the inorganic filler included in the solution of polyamide according to this disclosure is in the form of a fiber or particles. The material of the inorganic filler included in the solution of polyamide according to this disclosure is not particularly limited as long as it is an inorganic material. In one or plurality of embodiments, the inorganic filler may be a metal oxide such as silica, alumina, or titanium oxide, mineral such as mica, glass or a mixture thereof. Examples of the glass include E glass, C glass, A glass, S glass, D glass, NE glass, T glass, low dielectric constant glass and high dielectric constant glass.

When the inorganic filler is in the form of a fiber, the fiber has an average fiber diameter of 1 to 1000 nm in terms of reducing both the coefficient of thermal expansion of the film and retardation in film thickness direction as well as improving the transparency of the film. Here, the fiber may be composed of monofilaments that are arranged sufficiently apart from each other without being aligned such that a liquid precursor of a matrix resin can enter the space between the monofilaments. In this case, the average fiber diameter is the average diameter of the monofilaments. Further, the fiber may include a bundle of multiple monofilaments forming threads. In this case, the average fiber diameter is defined as the average diameter of the threads. Specifically, the average fiber diameter is measured by a method described in Examples. Further, the smaller the average fiber diameter of the fiber and the closer the refractive index of the polyamide resin contained in the solution of polyamide and the refractive index of the inorganic filler, the more preferable it is in terms of improving the transparency of the film. For example, when the difference in refractive index between the material of the fiber and the polyamide at 589 nm is 0.01 or less, highly transparent films can be formed regardless of the fiber diameter. Examples of ways to determine the average fiber diameter include observation under an electron microscope.

When the inorganic filler is in the form of particles, the average particle diameter of the particles is 1 to 1000 nm in terms of reducing both the coefficient of thermal expansion of the film and retardation in film thickness direction as well as improving the transparency of the film. Here, the average particle diameter of the particles refers to an average diameter of projected equivalent circles, and more specifically it is measured by a method described in Examples. The shape of the particles is not particularly limited. In one or plurality of embodiments, the shape may be sphere, rod, plate, or a bound shape thereof in terms of reducing both the coefficient of thermal expansion of the film and retardation in film thickness direction. Further, the smaller the average particle diameter of the particles and the closer the refractive index of the polyamide resin contained in the solution of polyamide and the refractive index of the inorganic filler, the more preferable it is in terms of improving the transparency of the film. For example, when the difference in refractive index between the material of the particles and the polyamide at 589 nm is 0.01 or less, highly transparent films can be formed regardless of the particle diameter. Further, the average particle diameter may be measured by, for example, using a particle diameter distribution meter.

In one or plurality of embodiments, the inorganic filler accounts for 1 vol % to 50 vol %, 2 vol % to 40 vol %, or 3 vol % to 30 vol % of the solid content of the solution of polyamide according to this disclosure. Further, the polyamide accounts for 50 vol % to 99 vol %, 60 to 98 vol %, or 70 to 97 vol % of the solid content of the solution of polyamide according to this disclosure. The term “solid content” as used herein refers to the components of the solution of polyamide other than the solvent. The solid content in terms of volume, the amount of the inorganic filler in terms of volume, and/or the amount of the polyamide in terms of volume can be calculated from the amount of each component introduced to prepare the solution of polyamide or can also be calculated by removing the solvent from the solution of polyamide.

In one or plurality of embodiments, a cast film formed by applying the solution of polyamide according to this disclosure to a substrate (e.g., a glass substrate or an inorganic substrate) has retardation in the thickness direction (Rth) of 200.0 nm or less, 190.0 nm or less, 180.0 nm or less, 175.0 nm or less or 173.0 nm or less at 400 nm in terms of using the film in a display element, an optical element or an illumination element. Note that Rth of the polyamide film is calculated using a retardation measurement device, and more specifically it is measured by a method described in Examples.

In one or plurality of embodiments, a cast film formed by applying the solution of polyamide according to this disclosure to a substrate (e.g., a glass substrate or an inorganic substrate) has a coefficient of thermal expansion (CTE) of 40.0 ppm/K or less, 36 ppm/K or less, 34 ppm/K or less, 32 ppm/K or less, or 30 ppm/K or less in terms of using the film in a display element, an optical element or an illumination element. In this disclosure, CTE of the polyamide film is measured using a thermal mechanical analyzer (TMA), and more specifically it is measured by a method described in Examples.

[Polyamide]

In one or plurality of embodiments, in terms of using the film in a display element, an optical element or an illumination element and reducing both the coefficient of thermal expansion of the film and retardation in film thickness direction, the aromatic polyamide of the solution of polyamide according to this disclosure includes an aromatic polyamide having repeat units of general formulas (I) and (II):

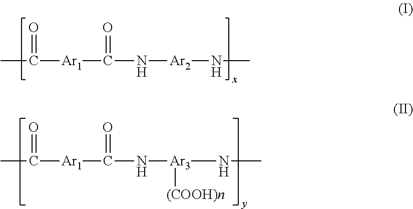

wherein x represents mole % of the repeat structure (I), y represents mole % of the repeat structure (II), x varies from 90 to 100, and y varies from 10 to 0;

wherein n=1 to 4;

wherein Ar₁ is selected from the group comprising:

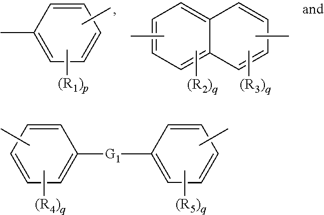

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters such as halogenated alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen (fluoride, chloride, bromide, and iodide); a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₂ is selected from the group of comprising:

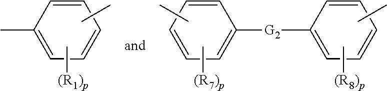

wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters such as halogenated alkyl esters, and combinations thereof. It is to be understood that each R₆ can be different, each R₇ can be different, and each R₈ can be different. G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₃ is selected from the group comprising:

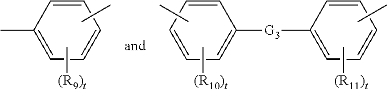

wherein t=0 to 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters such as halogenated alkyl esters, and combinations thereof. It is to be understood that each R₉ can be different, each R₁₀ can be different, and each R₁₁ can be different. G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

In one or plurality of embodiments of this disclosure, (I) and (II) are selected so that the polyamide is soluble in a polar solvent or a mixed solvent comprising one or more polar solvents. In one or plurality of embodiments of this disclosure, x varies from 90.0 to 99.99 mole % of the repeat structure (I), and y varies from 10.0 to 0.01 mole % of the repeat structure (II). In one or plurality of embodiments of this disclosure, x varies from 90.1 to 99.9 mole % of the repeat structure (I), and y varies from 9.9 to 0.1 mole % of the repeat structure (II). In one or plurality of embodiments of this disclosure, x varies from 90.0 to 99.0 mole % of the repeat structure (I), and y varies from 10.0 to 1.0 mole % of the repeat structure (II). In one or plurality of embodiments of this disclosure, x varies from 92.0 to 98.0 mole % of the repeat structure (I), and y varies from 8.0 to 2.0 mole % of the repeat structure (II). In one or plurality of embodiments of this disclosure, the aromatic polyamide contains multiple repeat units with the structures (I) and (II) where Ar₁, Ar₂, and Ar₃ are the same or different.

[Average Molecular Weight of Polyamide]

In one or plurality of embodiments, in terms of using the film in a display element, an optical element, or an illumination element and reducing both the coefficient of thermal expansion of the film and retardation in film thickness direction, it is preferable that the aromatic polyamide of the solution of polyamide according to this disclosure has a number-average molecular weight (Mn) of 6.0×10⁴ or more, 6.5×10⁴ or more, 7.0×10⁴ or more, 7.5×10⁴ or more, or 8.0×10⁴ or more. Similarly, in one or plurality of embodiments, the number-average molecular weight is 1.0×10⁶ or less, 8.0×10⁵ or less, 6.0×10⁵ or less, or 4.0×10⁵ or less. In this disclosure, the number-average molecular weight (Mn) and the weight-average molecular weight (Mw) of the polyamide are measured by Gel Permeation Chromatography, and more specifically, they are measured by a method described in Examples.

In one or plurality of embodiments, in terms of using the film in a display element, an optical element, or an illumination element and reducing both the coefficient of thermal expansion of the film and retardation in film thickness direction, it is preferable that the molecular weight distribution (=Mw/Mn) of the aromatic polyamide of the solution of polyamide according to this disclosure is 5.0 or less, 4.0 or less, 3.0 or less, 2.8 or less, 2.6 or less, or 2.4 or less. Similarly, in one or plurality of embodiments, the molecular weight distribution of the aromatic polyamide is 2.0 or more.

In one or plurality of embodiments, in terms of using the film in a display element, an optical element, or an illumination element, the solution of polyamide according to this disclosure is one undergone re-precipitation after the synthesis of the polyamide.

In one or plurality of embodiments of this disclosure, one or both of terminal —COOH group and terminal —NH₂ group of the aromatic polyamide are end-capped. The end-capping of the terminal is preferable from the point of enhancement of heat resistance property of the polyamide film. The terminal of the polyamide can be end-capped by the reaction of polymerized polyamide with benzoyl chloride when the terminal of Polyamide is —NH₂, or reaction of polymerized PA with aniline when the terminal of Polyamide is —COOH. However, the method of end-capping is not limited to this method.

[Solid Content]

In one or plurality of embodiments, in terms of using the film in a display element, an optical element, or an illumination element and reducing both the coefficient of thermal expansion of the film and retardation in film thickness direction, the solid content of the solution of polyamide according to this disclosure is 1 vol % or more, 2 vol % or more, or 3 vol % or more. Similarly, the solid content is 40 vol % or less, 30 vol % or less, or 20 vol % or less.

[Solvent]

In one or plurality of embodiments of this disclosure, in terms of enhancement of solubility of the polyamide to the solvent, the solvent is a polar solvent or a mixed solvent comprising one or more polar solvents. In one or plurality of embodiments of this disclosure, in terms of enhancement of solubility of the polyamide to the solvent and enhancement of the adhesion between polyamide film and the base, the solvent is methanol, ethanol, propanol, isopropanol (IPA), butanol, acetone, methyl ethyl ketone (MEK), methyl isobutyl ketone (MIBK), toluene, cresol, xylene, propyleneglycol monomethyl ether acetate (PGMEA), N,N-dimethylacetamide (DMAc), N-methyl-2-pyrrolidinone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-Butoxy-N,N-dimethylpropanamide, 1-Ethyl-2-pyrrolidone, N,N-Dimethylpropionamide, N,N-Dimethylbutyramide, N,N-Diethylacetamide, N,N-Diethylpropionamide, 1-Methyl-2-Piperidinone, Propylene carbonate, a combination thereof, or a mixed solvent comprising at least one of the solvents.

[Other Components]

As needed, the solution of polyamide according to this disclosure may contain an antioxidant, an ultraviolet absorber, a dye, a filler such as other inorganic filler and the like in small amounts so long as they do not compromise the effects of reducing the coefficient of thermal expansion of the film and retardation in film thickness direction and such properties as transparency, solvent resistance and heat resistance.

[Process for Manufacturing Solution of Polyamide]

In one or plurality embodiments, in terms of using the film in a display element, an optical element, or an illumination element and reducing both the coefficient of thermal expansion of the film and retardation in film thickness direction, the solution of polyamide according to this disclosure is one obtained or obtainable by a manufacturing process including the following steps. However, the solution of polyamide according to this disclosure is not limited to one manufactured by the following process.

a) dissolving at least one aromatic diamine in a solvent;

b) reacting the at least one aromatic diamine mixture with at least one aromatic diacid dichloride, wherein hydrochloric acid and a polyamide solution is generated;

c) removing the free hydrochloric acid by reaction with a trapping reagent;

d) adding the inorganic filler.

In one or more embodiments of the process for manufacturing a polyamide solution of this disclosure, the aromatic diacid dichloride is an aromatic dicarboxylic acid dichloride, and includes those shown in the following general structures:

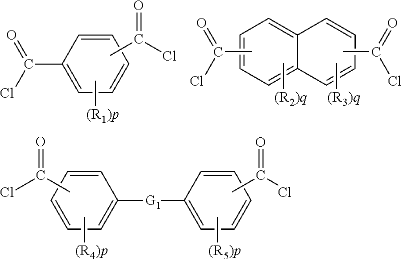

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, or substituted aryl such as halogenated aryls, alkyl ester and substituted alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

In one or plurality of embodiments, in terms of using the film in a display element, an optical element, or an illumination element and suppressing Rth, examples of the aromatic dicarboxylic acid dichloride used in the process for manufacturing the solution of polyamide according to this disclosure include the following.

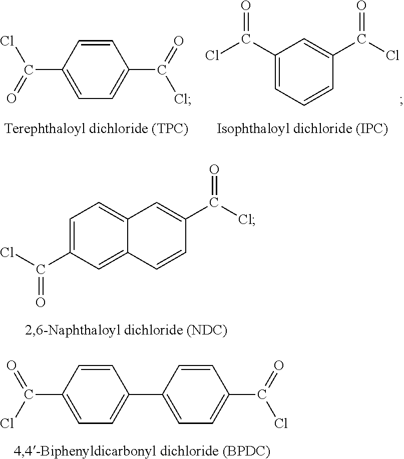

In one or more embodiments of the process for manufacturing a polyamide solution of this disclosure, the aromatic diamine includes those shown in the following general structures:

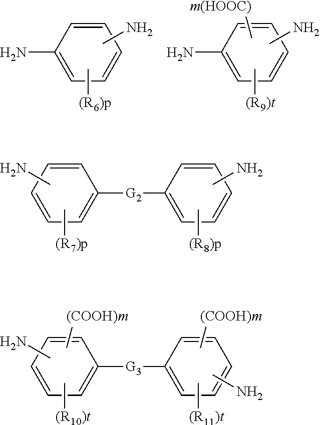

wherein p=4, m=1 or 2, and t=1 to 3, wherein R₆, R₇, R₈, R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, substituted aryl such as halogenated aryls, alkyl ester, and substituted alkyl esters, and combinations thereof. It is to be understood that each R₆ can be different, each R₇ can be different, each R₈ can be different, each R₉ can be different, each R₁₀ can be different, and each R₁₁ can be different. G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

In one or plurality of embodiments, in terms of using the film in a display element, an optical element, or an illumination element and suppressing Rth, examples of the aromatic diamine used in the process for manufacturing the solution of polyamide according this disclosure include the following.

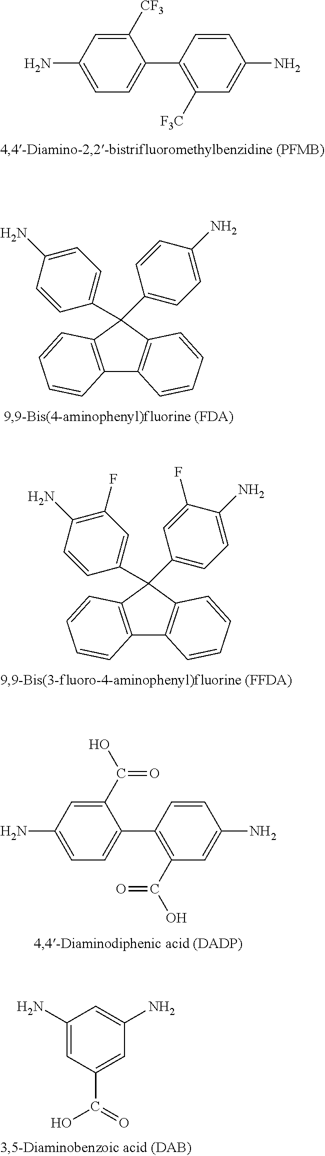 [SMILES: Nc1ccc(-c2ccc(N)cc2C(F)(F)F)c(C(F)(F)F)c1 ; Nc1ccc(C2(c3ccc(N)cc3)c3ccccc3-c3ccccc32)cc1 ; Nc1ccc(C2(c3ccc(N)c(F)c3)c3ccccc3-c3ccccc32)cc1F ; Nc1ccc(-c2ccc(N)cc2C(=O)O)c(C(=O)O)c1 ; Nc1cc(N)cc(C(=O)O)c1]

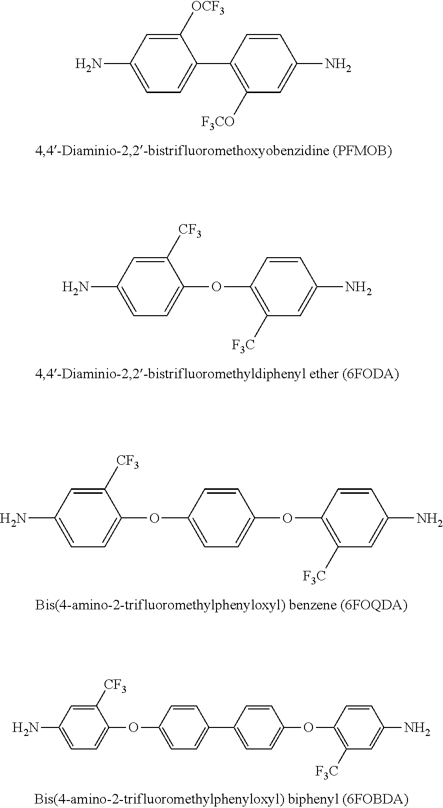 [SMILES: Nc1ccc(-c2ccc(N)cc2OC(F)(F)F)c(OC(F)(F)F)c1 ; Nc1ccc(Oc2ccc(N)cc2C(F)(F)F)c(C(F)(F)F)c1 ; Nc1ccc(Oc2ccc(Oc3ccc(N)cc3C(F)(F)F)cc2)c(C(F)(F)F)c1 ; Nc1ccc(Oc2ccc(-c3ccc(Oc4ccc(N)cc4C(F)(F)F)cc3)cc2)c(C(F)(F)F)c1]

In one or more embodiments of the process for manufacturing a polyamide solution of this disclosure, a polyamide is prepared via a condensation polymerization in a solvent, where the hydrochloric acid generated in the reaction is trapped by a reagent like propylene oxide (PrO).

In one or plurality of embodiments of this disclosure, in terms of use of the polyamide solution in the process for manufacturing a display element, an optical element or an illumination element, the reaction of hydrochloric acid with the trapping reagent yields a volatile product.

In one or plurality of embodiments of this disclosure, in terms of use of the polyamide solution in the process for manufacturing a display element, an optical element or an illumination element, the trapping reagent is propylene oxide. In one or plurality of embodiments of this disclosure, the trapping reagent is added to the mixture before or during the reacting step (b). Adding the reagent before or during the reaction step (b) can reduce degree of viscosity and generation of lumps in the mixture after the reaction step (b), and therefore, can improve productivity of the solution of the polyamide. These effects are significant specifically when the reagent is organic reagent, such as propylene oxide.

In one or plurality of embodiments of this disclosure, in terms of enhancement of heat resistance property of the polyamide film, the process further comprises the step of end-capping of one or both of terminal —COOH group and terminal —NH₂ group of the polyamide. The terminal of the polyamide can be end-capped by the reaction of polymerized polyamide with benzoyl chloride when the terminal of Polyamide is —NH₂, or reaction of polymerized PA with aniline when the terminal of Polyamide is —COOH. However, the method of end-capping is not limited to this method.

In one or plurality of embodiments of this disclosure, in terms of use of the polyamide solution in the process for manufacturing a display element, an optical element or an illumination element, the polyamide is first isolated from the polyamide solution by precipitation and redissolved in a solvent prior to the addition of the inorganic filler. The re-precipitation can be carried out by a typical method. In one or plurality of embodiments, by adding the polyamide to methanol, ethanol, isopropyl alcohol or the like, it is precipitated, cleaned, and dissolved in the solvent, for example.

As the solvent used in the production of the solution of polyamide, any of those described above can be used.

In one or plurality of embodiments of this disclosure, in terms of f use of the polyamide solution in the process for manufacturing a display element, an optical element or an illumination element, the solution is produced in the absence of inorganic salt.

In one or plurality of embodiments, the solution of polyamide according to this disclosure is a solution of polyamide for use in a process for manufacturing a display element, an optical element, or an illumination element, including the steps a) to c).

a) applying a solution of an aromatic polyamide onto a base;

b) forming a polyamide film on the base after the applying step (a); and

c) forming the display element, the optical element or the illumination element on the surface of polyamide film,

wherein the base or the surface of the base is composed of glass or silicon wafer.

[Laminated Composite Material]

The term “laminated composite material” as used herein refers to a material in which a base and a polyamide resin layer are laminated. In one or plurality of non-limiting embodiments, a base and a polyamide resin layer being laminated means that the base and the polyamide resin layer are laminated directly. Alternatively, in one or plurality of non-limiting embodiments, it means that the base and the polyamide resin layer are laminated through one or more layers.

In one or plurality of none-limiting embodiments, the laminated composite material according to this disclosure can be used in a process for manufacturing a display element, an optical element, or an illumination element, such as the one described in FIG. 2. Further, in one or plurality of none-limiting embodiments, the laminated composite material according to this disclosure can be used as a laminated composite material obtained in the step B of the manufacturing process described in FIG. 2. Therefore, in one or plurality of none-limiting embodiments, the laminated composite material according to this disclosure is a laminated composite material comprising a polyamide resin layer and a glass plate, the polyamide resin layer being laminated onto a surface of the glass plate. The laminated composite material is for use in a process for manufacturing a display element, an optical element, or an illumination element, including the step of forming the display element, the optical element, or the illumination element on a surface of the polyamide resin layer, wherein the surface is not opposed to the glass plate.

The laminated composite material according to this disclosure may include additional organic resin layers and/or inorganic layers in addition to the polyamide resin layer. In one or plurality of none-limiting embodiments, examples of additional organic resin layers include a flattening coat layer.

Further, in one or plurality of none-limiting embodiments, examples of inorganic layers include a gas barrier layer capable of suppressing permeation of water, oxygen, or the like and a buffer coat layer capable of suppressing migration of ions to a TFT element.

[Polyamide Resin Layer]

The polyamide resin of the polyamide resin layer of the laminated composite material according to this disclosure can be formed using the solution of polyamide according to this disclosure.

In one or plurality of embodiments, the inorganic filler in the polyamide resin layer of the laminated composite material according to this disclosure accounts for 1 vol % to 50 vol %, 2 vol % to 40 vol %, or 3 vol % to 30 vol % of the polyamide resin layer. The polyamide resin layer in terms of volume and/or the inorganic filler in terms of volume can be calculated from the amount of each component introduced to prepare the solution of polyamide or can be calculated by measuring the volume of the polyamide resin layer.

In one or plurality of embodiments, in terms of using the film in a display element, an optical element or an illumination element, the polyamide resin layer of the laminated composite material according to this disclosure has retardation in the thickness direction (Rth) of 200.0 nm or less, 190.0 nm or less, 180.0 nm or less, 175.0 nm or less or 173.0 nm or less at 400 nm. Specifically, Rth of the polyamide resin layer is measured by a method described in Examples.

In one or plurality of embodiments, the polyamide resin layer of the laminated composite material according to this disclosure has a coefficient of thermal expansion (CTE) of 40.0 ppm/K or less, 36 ppm/K or less, 34 ppm/K or less, 32 ppm/K or less, or 30 ppm/K or less in terms of using the film in a display element, an optical element or an illumination element. Specifically, CTE of the polyamide resin layer in this disclosure is measured by a method described in Examples.

[Thickness of Polyamide Resin Layer]

In one or plurality of embodiments, in terms of using the film in a display element, an optical element, or an illumination element and suppressing the development of cracks in the resin layer, the polyamide resin layer of the laminated composite material according to this disclosure has a thickness of 500 μm or less, 200 μm or less, or 100 μm or less. Further, in one or plurality of none-limiting embodiments, the polyamide resin layer has a thickness of 1 μm or more, 2 μm or more, or 3 μm or more, for example.

[Transmittance of Polyamide Resin Layer]

In one or plurality of embodiments, the polyamide resin layer of the laminated composite material according to this disclosure has a total light transmittance of 70% or more, 75% or more, or 80% or more in terms of allowing the laminated composite material to be used suitably in the production of a display element, an optical element, or an illumination element.

[Base]

In one or plurality of embodiments, in terms of using the film in a display element, an optical element, or an illumination element, the material of the base of the laminated composite material according to this disclosure may be, for example, glass, soda-lime glass, none-alkali glass, silicon wafer or the like.

In one or plurality of embodiments, in terms of using the film in a display element, an optical element, or an illumination element, the base of the laminated composite material according this disclosure has a thickness of 0.3 mm or more, 0.4 mm or more, or 0.5 mm or more. Further, in one or plurality of embodiments, the base has a thickness of 3 mm or less or 1 mm or less, for example.

[Process for manufacturing Laminated Composite Material]

In one or plurality of non-limiting embodiments, the laminated composite material according to this disclosure can be manufactured by applying the solution of polyamide according to this disclosure onto a base, and drying, and if necessary curing, the applied solution.

In one or plurality of embodiments of this disclosure, a process for manufacturing the laminated composite material of this disclosure includes the steps of:

a) applying a solution of an aromatic polyamide onto a base; and

b) heating the casted polyamide solution to form a polyamide film after the applying step (a).

In one or plurality of embodiments of this disclosure, in terms of suppression of curvature deformation and/or enhancement of dimension stability, the heating is carried out under the temperature ranging from approximately +40° C. of the boiling point of the solvent to approximately +100° C. of the boiling point of the solvent, preferably from approximately +60° C. of the boiling point of the solvent to approximately +80° C. of the boiling point of the solvent, more preferably approximately +70° C. of the boiling point of the solvent. In one or plurality of embodiments of this disclosure, in terms of suppression of curvature deformation and/or enhancement of dimension stability, the temperature of the heating in step (b) is between approximately 200° C. and approximately 250° C. In one or plurality of embodiments of this disclosure, in terms of suppression of curvature deformation and/or enhancement of dimension stability, the time of the heating is more than approximately 1 minute and less than approximately 30 minutes.

The process for manufacturing the laminated composite material may include, following the step (b), a curing step (c) in which the polyamide film is cured. The curing temperature depends upon the capability of a heating device but is 220 to 420° C., 280 to 400° C., 330° C. to 370° C., 340° C. or more or 340 to 370° C. in one or plurality of embodiments. Further, in one or plurality of embodiments, the curing time is 5 to 300 minutes or 30 to 240 minutes.

[Process for manufacturing Display Element, Optical Element or Illumination Element]

This disclosure, in one aspect, relates to a process for manufacturing a display element, an optical element, or an illumination element, which includes the step of forming the display element, the optical element, or the illumination element on a surface of the polyamide resin layer of the laminated composite material according to this disclosure, wherein the surface is not opposed to the base. In one or plurality of embodiments, the manufacturing process further includes the step of de-bonding the display element, the optical element, or the illumination element formed from the base.

[Display Element, Optical Element, or Illumination Element]

The term “a display element, an optical element, or an illumination element” as used herein refers to an element that constitutes a display (display device), an optical device, or an illumination device, and examples of such elements include an organic EL element, a liquid crystal element, and organic EL illumination. Further, the term also covers a component of such elements, such as a thin film transistor (TFT) element, a color filter element or the like. In one or more embodiments, the display element, the optical element or the illumination element according to the present disclosure may include the polyamide film according to the present disclosure, may be produced using the solution of polyamide according to the present disclosure, or may use the polyamide film according to the present disclosure as the substrate of the display element, the optical element or the illumination element.

<Non-limiting Embodiment of Organic EL Element>

Hereinafter, one embodiment of an organic EL element as one embodiment of the display element according to the present disclosure will be described with reference to the drawing.

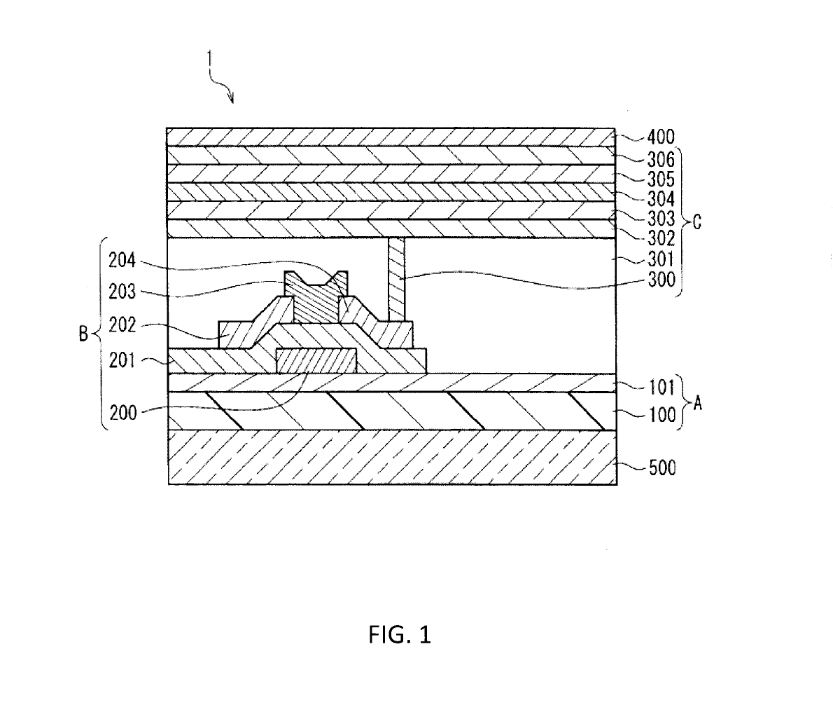

FIG. 1 is a schematic cross-sectional view showing an organic EL element 1 according to one embodiment. The organic EL element 1 includes a thin film transistor B formed on a substrate A and an organic EL layer C. Note that the organic EL element 1 is entirely covered with a sealing member 400. The organic EL element 1 may be separate from a base 500 or may include the base 500. Hereinafter, each component will be described in detail.

1. Substrate A

The substrate A includes a transparent resin substrate 100 and a gas barrier layer 101 formed on top of the transparent resin substrate 100. Here, the transparent resin substrate 100 is the polyamide film according to the present disclosure.

The transparent resin substrate 100 may have been annealed by heat. Annealing is effective in, for example, removing distortions and in improving the size stability against environmental changes.

The gas barrier layer 101 is a thin film made of SiOx, SiNx or the like, and is formed by a vacuum deposition method such as sputtering, CVD, vacuum deposition or the like. Generally, the gas barrier layer 101 has a thickness of, but is not limited to, about 10 nm to 100 nm. Here, the gas barrier layer 101 may be formed on the side of the transparent resin substrate 100 facing the gas barrier layer 101 in FIG. 1 or may be formed on the both sides of the transparent resin substrate 100.

2. Thin Film Transistor

The thin film transistor B includes a gate electrode 200, a gate insulating film 201, a source electrode 202, an active layer 203, and a drain electrode 204. The thin film transistor B is formed on the gas barrier layer 101.

The gate electrode 200, the source electrode 202, and the drain electrode 204 are transparent thin films made of indium tin oxide (ITO), indium zinc oxide (IZO), zinc oxide (ZnO), or the like. For example, sputtering, vapor deposition, ion platting or the like may be use to form these transparent thin films. Generally, these electrodes have a film thickness of, but is not limited to, about 50 nm to 200 nm.

The gate insulating film 201 is a transparent insulating thin film made of SiO₂, Al₂O₃ or the like, and is formed by sputtering, CVD, vacuum deposition, ion plating or the like. Generally, the gate insulating film 201 has a film thickness of, but is not limited to, about 10 nm to 1 μm.

The active layer 203 is a layer of, for example, single crystal silicon, low temperature polysilicon, amorphous silicon, or oxide semiconductor, and a material best suited to the active layer 203 is used as appropriate. The active layer is formed by sputtering or the like.

3. Organic EL Layer

The organic EL layer C includes a conductive connector 300, an insulative flattened layer 301, a lower electrode 302 as the anode of the organic EL element 1, a hole transport layer 303, a light-emitting layer 304, an electron transport layer 305, and an upper electrode 306 as the cathode of the organic EL element 1. The organic EL layer C is formed at least on the gas barrier layer 101 or on the thin film transistor B, and the lower electrode 302 and the drain electrode 204 of the thin film transistor B are connected to each other electrically through the connector 300. Instead, the lower electrode 302 of the thin film transistor B and the source electrode 202 may be connected to each other through the connector 300.

The lower electrode 302 is the anode of the organic EL element 1, and is a transparent thin film made of indium tin oxide (ITO), indium zinc oxide (IZO), zinc oxide (ZnO) or the like. ITO is preferred because, for example, high transparency, and high conductivity can be achieved.

For the hole transport layer 303, the light-emitting layer 304, and the electron transport layer 305, conventionally-known materials for organic EL elements can be used as is.

The upper electrode 306 is a film composed of a layer of lithium fluoride (LiF) having a film thickness of 5 nm to 20 nm and a layer of aluminum (Al) having a film thickness of 50 nm to 200 nm. For example, vapor deposition may be use to form the film.

When producing a bottom emission type organic EL element 1, the upper electrode 306 of the organic EL element 1 may be configured to have optical reflectivity. Thereby, the upper electrode 306 can reflect in the display side direction light generated by the organic EL element A and traveled toward the upper side as the opposite direction to the display side. Since the reflected light is also utilized for a display purpose, the emission efficiency of the organic EL element can be improved.

[Method of Producing Display Element, Optical Element, or Illumination Element]

Another aspect of the present disclosure relates to a method of producing a display element, an optical element, or an illumination element. In one or more embodiments, the production method according to the present disclosure is a method of producing the display element, the optical element, or the illumination element according to the present disclosure. Further, in one or more embodiments, the production method according to the present disclosure is a method of producing a display element, an optical element, or an illumination element, which includes the steps of applying the polyamide resin composition according to the present disclosure onto a base; forming a polyamide film after the application step; and forming the display element, the optical element, or the illumination element on the side of the base not in contact with the polyamide resin film. The production method according to the present disclosure may further include the step of de-bonding, from the base, the display element, the optical element, or the illumination element formed on the base.

<Non-limiting Embodiment of Method of Producing Organic EL Element>

As one embodiment of the method of producing a display element according to the present disclosure, hereinafter, one embodiment of a method of producing an organic EL element will be described with reference to the drawing.

A method of producing the organic EL element 1 shown in FIG. 1 includes a fixing step, a gas barrier layer preparation step, a thin film transistor preparation step, an organic EL layer preparation step, a sealing step and a de-bonding step. Hereinafter, each step will be described in detail.

1. Fixing Step

In the fixing step, the transparent resin substrate 100 is fixed onto the base 500. A way to fix the transparent resin substrate 100 to the base 500 is not particularly limited. For example, an adhesive may be applied between the base 500 and the transparent substrate or a part of the transparent resin substrate 100 may be fused and attached to the base 500 to fix the transparent resin substrate 100 to the base 500. Further, as the material of the base, glass, metal, silicon, resin or the like is used, for example. These materials may be used alone or in combination of two or more as appropriate. Furthermore, the transparent resin substrate 100 may be attached to the base 500 by applying a releasing agent or the like to the base 500 and placing the transparent resin substrate 100 on the applied releasing agent. In one or more embodiments, the polyamide film 100 is formed by applying the polyamide resin composition according to the present disclosure to the base 500, and drying the applied polyamide resin composition.

2. Gas Barrier Layer Preparation Step

In the gas barrier layer preparation step, the gas barrier layer 101 is prepared on the transparent resin substrate 100. A way to prepare the gas barrier layer 101 is not particularly limited, and a known method can be used.

3. Thin Film Transistor Preparation Step

In the thin film transistor preparation step, the thin film transistor B is prepared on the gas barrier layer. Away to prepare the thin film transistor B is not particularly limited, and a known method can be used.

4. Organic EL Layer Preparation Step

The organic EL layer preparation step includes a first step and a second step. In the first step, the flattened layer 301 is formed. The flattened layer 301 can be formed by, for example, spin-coating, slit-coating, or ink-jetting a photosensitive transparent resin. At that time, an opening needs to be formed in the flattened layer 301 so that the connector 300 can be formed in the second step. Generally, the flattened layer has a film thickness of, but is not limited to, about 100 nm to 2 μm.

In the second step, first, the connector 300 and the lower electrode 302 are formed at the same time. Sputtering, vapor deposition, ion platting or the like may be used to form the connector 300 and the lower electrode 302. Generally, these electrodes have a film thickness of, but is not limited to, about 50 nm to 200 nm. Subsequently, the hole transport layer 303, the light-emitting layer 304, the electron transport layer 305, and the upper electrode 306 as the cathode of the organic EL element A are formed. To form these components, a method such as vapor deposition, application, or the like can be used as appropriate in accordance with the materials to be used and the laminate structure. Further, irrespective of the explanations given in this example, other layers may be chosen from known organic layers such as a hole injection layer, an electron transport layer, a hole blocking layer and an electron blocking layer as needed and be used to configuring the organic layers of the organic EL element A.

5. Sealing Step

In the sealing step, the organic EL layer C is sealed with the sealing member 400 from top of the upper electrode 306. For example, a glass material, a resin material, a ceramics material, a metal material, a metal compound or a composite thereof can be used to form the sealing member 400, and a material best suited to the sealing member 400 can be chosen as appropriate.

6. De-Bonding Step

In the de-bonding step, the organic EL element 1 prepared is stripped from the base 500. To implement the de-bonding step, for example, the organic EL element 1 may be physically stripped from the base 500. At that time, the base 500 may be provided with a de-bonding layer, or a wire may be inserted between the base 500 and the display element to remove the organic EL element. Further, examples of other methods of de-bonding the organic EL element 1 from the base 500 include the following: forming a de-bonding layer on the base 500 except at ends, and cutting, after the preparation of the element, the inner part from the ends to remove the element from the base; providing a layer of silicon or the like between the base 500 and the element, and irradiating the silicon layer with a laser to strip the element; applying heat to the base 500 to separate the base 500 and the transparent substrate from each other; and removing the base 500 using a solvent. These methods may be used alone or any of these methods may be used in combination of two or more. Especially in one or more embodiments, the strength of adhesion between PA film and the Base can be controlled by silane coupling agent, so that the organic EL element 1 may be physically stripped without using the complicated process such as described above.

In one or more embodiments, the organic EL element obtained by the method of producing a display, optical or illumination element according to the present embodiment has excellent characteristics such as excellent transparency and heat-resistance, low linear expansivity and low optical anisotropy.

[Display Device, Optical Device, and Illumination Device]

Another aspect of the present disclosure relates to a display device, an optical device, or an illumination device using the display element, the optical element, or the illumination element according to the present disclosure, or a method of producing the display device, the optical device, or the illumination device. Examples of the display device include, but are not limited to, an imaging element, examples of the optical device include, but are not limited to, a photoelectric complex circuit, and examples of the illumination device include, but are not limited to, a TFT-LCD and OEL illumination.

### EXAMPLES

### Example 1

To a 250 ml three necked round bottom flask, equipped with a mechanical stirrer, a nitrogen inlet and outlet, are added PFMB (3.042 g, 0.0095 mol), DAB (0.0761 g, 0.0005 mol) and DMAc (30 ml). After the PFMB and DAB dissolved completely, PrO (1.4 g, 0.024 mol) was added to the solution. The solution is cooled to 0° C. Under stirring, TPC (0.201 g, 0.00099 mol) and IPC (1.89 g, 0.00891 mol) was added to the solution, and the flask wall was washed with DMAc (1.5 ml). After two hours, benzoyl chloride (0.032 g, 0.23 mmol) was added to the solution and stirred for another two hours. After that, DMAC-ST (Nissan Chemical, DMAc solution that has 20 wt % of silica (average diameter:10 nm).) was added (11.23 g). The solid content of the solution of polyamide was about 9.8 vol % (about 15.6 wt %), and the silica accounted for about 25.8 vol % (about 30.0 wt %) of the solid content and the polyamide accounted for about 74.2 vol % (about 70.0 wt %) of the solid content.

### [Formation of Polyamide Films]

The solution of polyamide prepared was casted onto glass substrates to form films, and the properties of the films were studied. The solution of polyamide was applied onto flat glass substrates (10 cm×10 cm, trade name: EAGLE XG from Corning Inc., USA) by spin coating. After drying the casted solution for 30 minutes or more at 60° C., the temperature was increased from 60° C. to 330° C. or 350° C., and the temperature was maintained at 330° C. or 350° C. for 30 minutes under vacuum or in an inert atmosphere to cure the films. The polyamide films obtained had a thickness of about 10 μm. Each property was measured as follows.

### [Coefficient of Thermal Expansion (CTE)]

As the coefficient of thermal expansion (CTE) of the polyamide films, an average coefficient of thermal expansion determined in the following manner was adopted. First, the temperature of samples was increased from 30° C. to 300° C. at a rate of 10° C./min in a nitrogen atmosphere, followed by maintaining the temperature at 300° C. for 30 minutes, and then cooled to 25° C. at a rate of 10° C./min, and the average coefficient of thermal expansion of the samples undergone the process was measured using TMA4000SA from Bruker AXS. The width of each sample was 5 mm, and the load was 2 g. The measurement was carried out in the tensile mode. The average coefficient of thermal expansion was determined using the following formula.

Average Coefficient of Thermal Expansion(ppm/K)=((L₃₀₀−L₃₀)/L₃₀)/(300−30)×10⁶
L₃₀₀: the sample length at 300° C.
L₃₀: the sample length at 30° C.

### [Retardation in Thickness Direction (Rth)]

Retardation in thickness direction of the polyamide films at 400 nm was calculated as follows. With a retardation measurement device (KOBRA-21 ADH from Oji Scientific Instruments), the retardation between 0° and 40° was measured using the wavelength dispersion measurement mode (light at 479.2 nm, 545.4 nm, 630.3 nm, and 748.9 nm), and the retardation between 0° and 40° at 400 nm was calculated using the Sellmeier equation, and from the value and refractive index obtained, Rth at an arbitrary wavelength (400 nm in this case) was calculated. The films manufactured using the solution of Example 1 had a coefficient of thermal expansion (CTE) of 35 ppm/K and retardation in thickness direction (Rth) of 90 nm.

As Comparative example 1, a polyamide film was formed by using a polyamide solution prepared in the same manner as that of Example 1 except that the filler DMAC-ST was not added. The films manufactured using the solution of Comparative example 1 had a coefficient of thermal expansion (CTE) of 49 ppm/K and retardation in thickness direction (Rth) of 155 nm.

With regard to the embodiments described above, this disclosure further relates to the following composition, manufacturing process or use.

[A1] A solution of polyamide comprising an aromatic polyamide, an inorganic filler and a solvent.

[A2] The solution according to [A1], wherein the inorganic filler is in the form of fibers or particles.

[A3] The solution according to [A2], wherein the average fiber diameter of the fibers is 1 to 1000 nm.

[A4] The solution according to [A2], wherein the average particle diameter of the particle is 1 to 1000 nm.

[A5] The solution according to [A2] or [A4], wherein the shape of the particles is selected from the group consisting of sphere, rod, plate, and a bound shape thereof.

[A6] The solution according to any one of [A1] to [A5], wherein the material of the inorganic filler is selected from the group consisting of metal oxide, mineral, glass, or a mixture with constituents thereof.

[A7] The solution according to any one of [A1] to [A6], wherein the content of the inorganic filler is 1 to 90 wt %.

[A8] The solution according to any one of [A1] to [A7], wherein retardation at 400 nm of thickness direction of a cast film formed by applying the solution onto a base is 200 nm or less.

[A9] The solution according to any one of [A1] to [A8], wherein coefficient of thermal expansion (CTE) of a cast film formed by applying the solution onto a base is 40 ppm/K or less.

[A10] The solution according to any one of [A1] to [A9], wherein at least one of terminals of the aromatic polyamide is end-capped.

[A11] The solution according to any one of [A1] to [A10], wherein the aromatic polyamide comprising:
an aromatic polyamide having repeat units of general formulas (I) and (II):

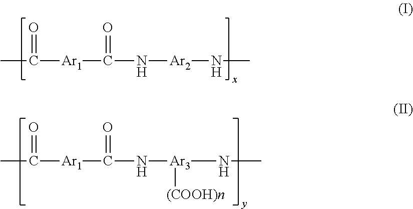

wherein x represents mole % of the repeat structure (I), y represents mole % of the repeat structure (II), x varies from 90 to 100 mole %, and y varies from 0 to 10 mole %;

wherein n=1 to 4;

wherein Ar₁ is selected from the group comprising:

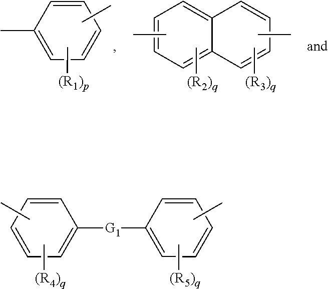

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters such as halogenated alkyl esters, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₂ is selected from the group of comprising:

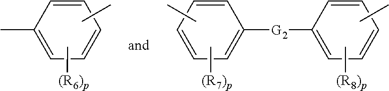

wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters such as halogenated alkyl esters, and combinations thereof, wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₃ is selected from the group comprising:

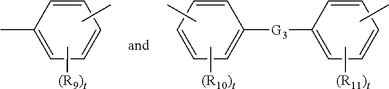

wherein t=0 to 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters such as halogenated alkyl esters, and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

[A12] The solution according to [A11], wherein (I) and (II) are selected so that the polyamide is soluble in a polar solvent or a mixed solvent comprising one or more polar solvents.

[A13] The solution according to [A11] or [A12], wherein x varies from 90 to 99 mole % of the repeat structure (I), and y varies from 1 to 10 mole % of the repeat structure (II).

[A14] The solution according to any one of [A11] to [A13], wherein the aromatic polyamide contains multiple repeat units with the structures (I) and (II) where Ar₁, Ar₂, and Ar₃ are the same or different.

[A15] The solution according to any one of [A1] to [A14], wherein the solvent is a polar solvent or a mixed solvent comprising one or more polar solvents.

[A16] The solution according to any one of [A1] to [A15], wherein the solvent is an organic and/or an inorganic solvent.

[A17] The solution according to any one of [A1] to [A16], wherein the solvent is methanol, ethanol, propanol, isopropanol (IPA), butanol, acetone, methyl ethyl ketone (MEIO, methyl isobutyl ketone (MIBK), toluene, cresol, xylene, propyleneglycol monomethyl ether acetate (PGMEA), N,N-dimethylacetamide (DMAc), N-methyl-2-pyrrolidinone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-Butoxy-N,N-dimethylpropanamide, 1-Ethyl-2-pyrrolidone, N,N-Dimethylpropionamide, N,N-Dimethylbutyramide, N,N-Diethylacetamide, N,N-Diethylpropionamide, 1-Methyl-2-Piperidinone, Propylene carbonate, a combination thereof, or a mixed solvent comprising at least one of the solvents.

[A18] The solution according to any one of [A1] to [A17], wherein the aromatic polyamide is obtained by a process comprising the steps of
a) dissolving at least one aromatic diamine in a solvent;
b) reacting the at least one aromatic diamine with at least one aromatic diacid dichloride, wherein hydrochloric acid and a polyamide solution is generated;
c) removing the free hydrochloric acid by reaction with a trapping reagent;
d) adding the inorganic filler.

[A19] The solution according to [A18], wherein one of the aromatic diamine is selected from the group comprising 4,4′-diamino-2,2′-bistrifluoromethylbenzidine, 9,9-bis(4-aminophenyl) fluorene, 9,9-bis(3-fluoro-4-aminophenyl) fluorene, 2,2′-bistrifluoromethoxylbenzidine, 4,4′-diamino-2,2′-bistrifluoromethyldiphenyl ether, bis-(4-amino-2-trifluoromethylphenyloxyl)benzene, and bis-(4-amino-2-trifluoromethylphenyloxyl) biphenyl.

[A20] The solution according to [A18] or [A19], wherein the at least one aromatic diacid dichloride is selected from the group comprising terephthaloyl dichloride, isophthaloyl dichloride, 2,6-naphthaloyl dichloride, and 4,4,-biphenyldicarbonyl dichloride.

[A21] The solution according to any one of [A18] to [A20], wherein the solvent is a polar solvent or a mixed solvent comprising one or more polar solvents.

[A22] The solution according to any one of [A18] to [A21], wherein the solvent is an organic and/or an inorganic solvent.

[A23] The solution according to any one of [A18] to [A22], wherein the solvent is methanol, ethanol, propanol, isopropanol (IPA), butanol, acetone, methyl ethyl ketone (MEK), methyl isobutyl ketone (MIBK), toluene, cresol, xylene, propyleneglycol monomethyl ether acetate (PGMEA), N,N-dimethylacetamide (DMAc), N-methyl-2-pyrrolidinone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-Butoxy-N,N-dimethylpropanamide, 1-Ethyl-2-pyrrolidone, N,N-Dimethylpropionamide, N,N-Dimethylbutyramide, N,N-Diethylacetamide, N,N-Diethylpropionamide, 1-Methyl-2-Piperidinone, Propylene carbonate, a combination thereof, or a mixed solvent comprising at least one of the solvents.

[A24] The solution according to any one of [A18] to [A23], wherein one of the diamine is 4,4′-diaminodiphenic acid or 3,5-diaminobenzoic acid.

[A25] The solution according to any one of [A18] to [A24], wherein the reaction of hydrochloric acid with the trapping reagent yields a volatile product.

[A26] The solution according to any one of [A18] to [A25], wherein the trapping reagent is propylene oxide.

[A27] The solution according to any one of [A18] to [A26], wherein the trapping reagent is added to the mixture before or during the reacting step (b).

[A28] The solution according to any one of [A18] to [A27], wherein the process further comprises the step of end-capping of one or both of terminal —COOH group and terminal —NH₂ group of the polyamide.

[A29] The solution according to any one of [A18] to [A28], wherein the polyamide is first isolated from the polyamide solution by precipitation and redissolved in a solvent prior to the addition of the inorganic filler.

[A30] The solution according to any one of [A18] to [A29], wherein the solution is produced in the absence of inorganic salt.

[B1] A process for manufacturing a solution of an aromatic polyamide comprising the steps of:
a) dissolving at least one aromatic diamine in a solvent;
b) reacting the at least one aromatic diamine mixture with at least one aromatic diacid dichloride, wherein hydrochloric acid and a polyamide solution are generated;
c) removing the free hydrochloric acid by reaction with a trapping reagent;
d) adding an inorganic filler.

[B2] The process according to [B1], wherein the inorganic filler is in the form of fibers or particles.

[B3] The process according to [B2], wherein the average fiber diameter of the fibers is 1 to 1000 nm.

[B4] The process according to [B2], wherein the average particle diameter of the particle is 1 to 1000 nm.

[B5] The process according to [B2] or [B4], wherein the shape of the particle is selected from the group consisting of sphere, rod, plate, and a bound shape thereof.

[B6] The process according to any one of [B1] to [B5], wherein the material of the inorganic filler is selected from the group consisting of metal oxide, mineral, glass, or a mixture with constituents thereof.

[B7] The process according to any one of [B1] to [B6], wherein the content of the inorganic filler in the solution is 1 to 90 wt %.

[B8] The process according to any one of [B1] to [B7], wherein retardation at 400 nm of thickness direction of a cast film formed by applying the solution onto a base is 200 nm or less.

[B9] The process according to any one of [B1] to [B8], wherein coefficient of thermal expansion (CTE) of a cast film formed by applying the solution onto a base is 40 ppm/K or less.

[B10] The process according to any one of [B1] to [B9], wherein one of the aromatic diamine is selected from the group comprising 4,4′-diamino-2,2′-bistrifluoromethylbenzidine, 9,9-bis(4-aminophenyl) fluorene, 9,9-bis(3-fluoro-4-aminophenyl) fluorene, 2,2′-bistrifluoromethoxylbenzidine, 4,4′-diamino-2,2′-bistrifluoromethyldiphenyl ether, bis-(4-amino-2-trifluoromethylphenyloxyl)benzene, and bis-(4-amino-2-trifluoromethylphenyloxyl) biphenyl.

[B11] The process according to any one of [B1] to [B10], wherein the at least one aromatic diacid dichloride is selected from the group comprising terephthaloyl dichloride, isophthaloyl dichloride, 2,6-naphthaloyl dichloride, and 4,4,-biphenyldicarbonyl dichloride.

[B12] The process according to any one of [B1] to [B11], wherein the solvent is a polar solvent or a mixed solvent comprising one or more polar solvents.

[B13] The process according to any one of [B1] to [B12], wherein the solvent is an organic and/or an inorganic solvent.

[B14] The process according to any one of [B1] to [B13], wherein the solvent is methanol, ethanol, propanol, isopropanol (IPA), butanol, acetone, methyl ethyl ketone (MEK), methyl isobutyl ketone (MIBK), toluene, cresol, xylene, propyleneglycol monomethyl ether acetate (PGMEA), N,N-dimethylacetamide (DMAc), N-methyl-2-pyrrolidinone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-Butoxy-N,N-dimethylpropanamide, 1-Ethyl-2-pyrrolidone, N,N-Dimethylpropionamide, N,N-Dimethylbutyramide, N,N-Diethylacetamide, N,N-Diethylpropionamide, 1-Methyl-2-Piperidinone, Propylene carbonate, a combination thereof, or a mixed solvent comprising at least one of the solvents.

[B15] The process according to any one of [B1] to [B14], wherein one of the diamine is 4,4′-diaminodiphenic acid or 3,5-diaminobenzoic acid.

[B16] The process according to any one of [B1] to [B15], wherein the reaction of hydrochloric acid with the trapping reagent yields a volatile product.

[B17] The process according to any one of [B1] to [B16], wherein the trapping reagent is propylene oxide.

[B18] The process according to any one of [B1] to [B17], wherein the trapping reagent is added to the mixture before or during the reacting step (b).

[B19] The process according to any one of [B1] to [B18], wherein the process further comprises the step of end-capping of one or both of terminal —COOH group and terminal —NH₂ group of the polyamide.

[B20] The process according to any one of [B1] to [B19], wherein the polyamide is first isolated from the polyamide solution by precipitation and redissolved in a solvent prior to the addition of the inorganic filler.

[B21] The process according to any one of [B1] to [B20], wherein the solution is produced in the absence of inorganic salt.

[C1] A laminated composite material, comprising a base, and a polyamide resin layer;

wherein the polyamide resin layer is laminated to one surface of the base;

wherein the polyamide resin layer is obtained or obtainable by applying a polyamide solution comprising an aromatic polyamide, an inorganic filler and a solvent onto the base.

[C2] The laminated composite material according to [C1], wherein the inorganic filler is in the form of fibers or particles.

[C3] The laminated composite material according to [C2], wherein the average fiber diameter of the fibers is 1 to 1000 nm.

[C4] The laminated composite material according to [C2], wherein the average particle diameter of the particle is 1 to 1000 nm.

[C5] The laminated composite material according to [C2] or [C4], wherein the shape of the particle is selected from the group consisting of sphere, rod, plate, and a bound shape thereof.

[C6] The laminated composite material according to any one of [C1] to [C5], wherein the material of the inorganic filler is selected from the group consisting of metal oxide, mineral, glass, or a mixture with constituents thereof.

[C7] The laminated composite material according to any one of [C1] to [C6], wherein the content of the inorganic filler in the polyamide solution is 1 to 90 wt %.

[C8] The laminated composite material according to any one of [C1] to [C7], wherein retardation at 400 nm of thickness direction of the polyamide resin layer is 200 nm or less.

[C9] The laminated composite material according to any one of [C1] to [C8], wherein coefficient of thermal expansion (CTE) of the polyamide resin layer is 40 ppm/K or less.

[C10] The laminated composite material according to any one of [C1] to [C9], wherein at least one of terminals of the aromatic polyamide is end-capped.

[C11] The laminated composite material according to any one of [C1] to [C10], wherein the aromatic polyamide comprising:
an aromatic polyamide having repeat units of general formulas (I) and (II):

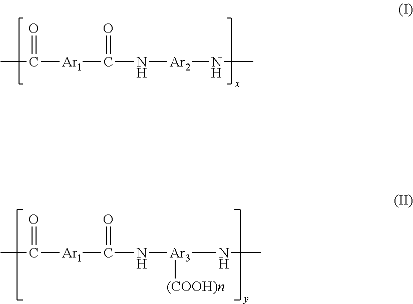

wherein x represents mole % of the repeat structure (I), y represents mole % of the repeat structure (II), x varies from 90 to 100, and y varies from 0 to 10;

wherein n=1 to 4;

wherein Ar₁ is selected from the group comprising:

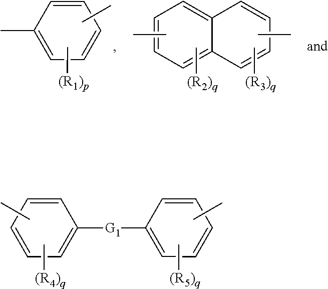

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters such as halogenated alkyl esters, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₂ is selected from the group of comprising:

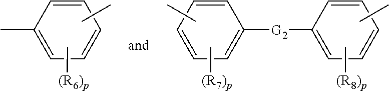

wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters such as halogenated alkyl esters, and combinations thereof, wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₃ is selected from the group comprising:

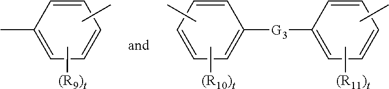

wherein t=0 to 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters such as halogenated alkyl esters, and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

[C12] The laminated composite material according to [C11], wherein (I) and (II) are selected so that the polyamide is soluble in a polar solvent or a mixed solvent comprising one or more polar solvents.

[C13] The laminated composite material according to [C11] or [C12], wherein x varies from 90 to 99 mole % of the repeat structure (I), and y varies from 1 to 10 mole % of the repeat structure (II).

[C14] The laminated composite material according to any one of [C11] to

[C13], wherein the aromatic polyamide contains multiple repeat units with the structures (I) and (II) where Ar₁, Ar₂, and Ar₃ are the same or different.

[C15] The laminated composite material according to any one of [C1] to [C14], wherein the solvent is a polar solvent or a mixed solvent comprising one or more polar solvents.

[C16] The laminated composite material according to any one of [C1] to [C15], wherein the solvent is an organic and/or an inorganic solvent.

[C17] The laminated composite material according to any one of [C1] to [C16], wherein the solvent is methanol, ethanol, propanol, isopropanol (IPA), butanol, acetone, methyl ethyl ketone (MEK), methyl isobutyl ketone (MIBK), toluene, cresol, xylene, propyleneglycol monomethyl ether acetate (PGMEA), N,N-dimethylacetamide (DMAc), N-methyl-2-pyrrolidinone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-Butoxy-N,N-dimethylpropanamide, 1-Ethyl-2-pyrrolidone, N,N-Dimethylpropionamide, N,N-Dimethylbutyramide, N,N-Diethylacetamide, N,N-Diethylpropionamide, 1-Methyl-2-Piperidinone, Propylene carbonate, a combination thereof, or a mixed solvent comprising at least one of the solvents.

[C18] The laminated composite material according to any one of [C1] to [C17], wherein the polyamide resin layer is produced in the absence of inorganic salt.

[C19] The laminated composite material according to any one of [C1] to [C18], wherein the base or the surface of the base is composed of glass or silicon wafer.

[C20] A display element, an optical element or an illumination element manufactured using the laminated composite material according to any one of [C1] to [C19], comprising a polyamide resin layer of the laminated composite material.

[D1] A process for manufacturing a display element, an optical element or an illumination element, comprising the steps of
a) casting a solution of an aromatic polyamide into a film onto a base; and
b) forming the display element, the optical element or the illumination element on the surface of the polyamide film;

wherein the solution of an aromatic polyamide comprising an aromatic polyamide, a solvent, and an inorganic filler,

wherein the base or the surface of the base is composed of glass or silicon wafer.

[D2] The process according to [D1], wherein the inorganic filler is in the form of fibers or particles.

[D3] The process according to [D2], wherein the average fiber diameter of the fibers is 1 to 1000 nm.

[D4] The process according to [D2], wherein the average particle diameter of the particle is 1 to 1000 nm.

[D5] The process according to [D2] or [D4], wherein the shape of the particle is selected from the group consisting of sphere, rod, plate, and a bound shape thereof.

[D6] The process according to any one of [D1] to [D5], wherein the material of the inorganic filler is selected from the group consisting of metal oxide, mineral, glass, or a mixture with constituents thereof.

[D7] The process according to any one of [D1] to [D6], wherein the content of the inorganic filler is 1 to 90 wt %.

[D8] The process according to any one of [D1] to [D7], wherein retardation at 400 nm of thickness direction of the polyamide film is 200 nm or less.

[D9] The process according to any one of [D1] to [D8], wherein coefficient of thermal expansion (CTE) of the polyamide film is 40 ppm/K or less.

[D10] The process according to any one of [D1] to [D9], wherein at least one of terminals of the aromatic polyamide is end-capped.

[D11] The process according to any one of [D1] to [D10], wherein the aromatic polyamide comprising:
an aromatic polyamide having repeat units of general formulas (I) and (II):

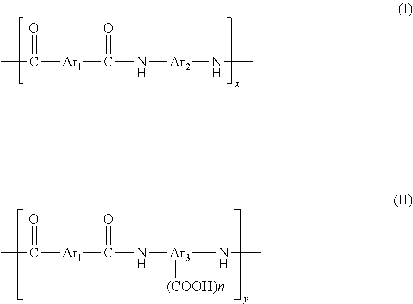

wherein x represents mole % of the repeat structure (I), y represents mole % of the repeat structure (II), x varies from 90 to 100, and y varies from 0 to 10;

wherein n=1 to 4;

wherein Ar₁ is selected from the group comprising:

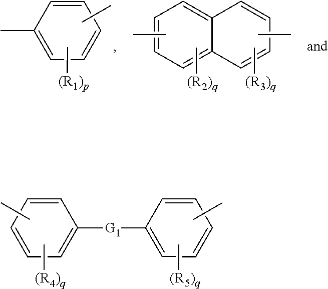

wherein p=3, q=4, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters such as halogenated alkyl esters, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₂ is selected from the group of comprising:

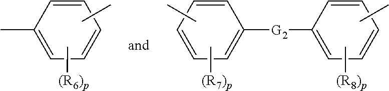

wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters such as halogenated alkyl esters, and combinations thereof, wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₃ is selected from the group comprising:

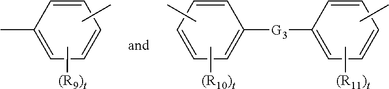

wherein t=2 or 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters such as halogenated alkyl esters, and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

[D12] The process according to [D11], wherein (I) and (II) are selected so that the polyamide is soluble in a polar solvent or a mixed solvent comprising one or more polar solvents.

[D13] The process according to [D11] or [D12], wherein x varies from 90 to 99 mole % of the repeat structure (I), and y varies from 1 to 10 mole % of the repeat structure (II).

[D14] The process according to any one of [D11] to [D13], wherein the aromatic polyamide contains multiple repeat units with the structures (I) and (II) where Ar₁, Ar₂, and Ar₃ are the same or different.

[D15] The process according to any one of [D1] to [D14], wherein the solvent is a polar solvent or a mixed solvent comprising one or more polar solvents.

[D16] The process according to any one of [D1] to [D15], wherein the solvent is an organic and/or an inorganic solvent.

[D17] The process according to any one of [C1] to [C16], wherein the solvent is methanol, ethanol, propanol, isopropanol (IPA), butanol, acetone, methyl ethyl ketone (MEK), methyl isobutyl ketone (MIBK), toluene, cresol, xylene, propyleneglycol monomethyl ether acetate (PGMEA), N,N-dimethylacetamide (DMAc), N-methyl-2-pyrrolidinone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-Butoxy-N,N-dimethylpropanamide, 1-Ethyl-2-pyrrolidone, N,N-Dimethylpropionamide, N,N-Dimethylbutyramide, N,N-Diethylacetamide, N,N-Diethylpropionamide, 1-Methyl-2-Piperidinone, Propylene carbonate, a combination thereof, or a mixed solvent comprising at least one of the solvents.

[D18] The process according to any one of [D1] to [D17], wherein the film is produced in the absence of inorganic salt.

[D19] The process according to any one of [D1] to [D18], further comprising the step of
c) de-bonding, from the base, the display element, the optical element or the illumination element formed on the base.

[D20] A display element, an optical element or an illumination element obtained or obtainable by the process according to any one of [D1] to [D19], comprising a polyamide film, wherein the polyamide film comprises the inorganic filler.

The embodiments have been described, hereinabove. It will be apparent to those skilled in the art that the above methods and apparatuses may incorporate changes and modifications without departing from the general scope of this disclosure. It is intended to include all such modifications and alterations insofar as they come within the scope of the appended claims or the equivalents thereof. Although the description above contains much specificity, this should not be construed as limiting the scope of the disclosure, but as merely providing illustrations of some of the embodiments of this disclosure. Various other embodiments and ramifications are possible within its scope.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

What is claimed is:

1. A solution of polyamide comprising:
an aromatic polyamide, an inorganic filler and a solvent.

2. The solution according to claim 1, wherein the shape of the particle is selected from the group consisting of sphere, rod, plate, and a bound shape thereof.

3. The solution according to claim 2, wherein the material of the inorganic filler is selected from the group consisting of metal oxide, mineral, glass, or a mixture with constituents thereof.

4. The solution according to claim 3, wherein the average fiber diameter of the fibers is 1 to 1000 nm.

5. The solution according to claim 3, wherein the average particle diameter of the particle is 1 to 1000 nm.

6. The solution according to claim 1, wherein the content of the inorganic filler is 1 to 90 wt %.

7. The solution according to claim 1, wherein retardation at 400 nm of thickness direction of a cast film formed by applying the solution onto a base is 200 nm or less.

8. The solution according to claim 1, wherein coefficient of thermal expansion (CTE) of a cast film formed by applying the solution onto a base is 40 ppm/K or less.

9. The solution according to claim 1, wherein the aromatic polyamide comprising:
an aromatic polyamide having repeat units of general formulas (I) and (II): 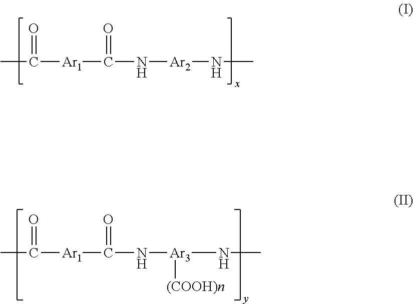
wherein x represents mole % of the repeat structure (I), y represents mole % of the repeat structure (II), x varies from 90 to 100 mole %, and y varies from 0 to 10 mole %;
wherein n=1 to 4;
wherein Ar₁ is selected from the group comprising: 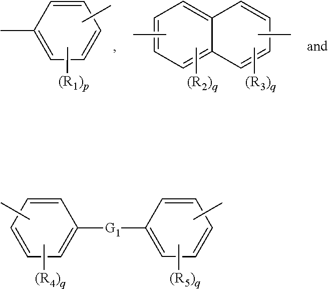
wherein p=4, q=3, and wherein R₁, R₂, R₃, R₄, R₅ are selected from the group comprising hydrogen, halogen, alkyl, substituted alkyl, nitro, cyano, thioalkyl, alkoxy, substituted alkoxy, aryl, substituted aryl, alkyl ester, substituted alkyl ester, and combinations thereof,
wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group;
wherein Ar₂ is selected from the group of comprising: 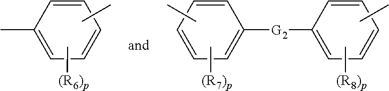
wherein p=4, wherein R₆, R₇, R₈ are selected from the group comprising hydrogen, halogen, alkyl, substituted alkyl, nitro, cyano, thioalkyl, alkoxy, substituted alkoxy, aryl, substituted aryl, alkyl ester, substituted alkyl ester, and combinations thereof,
wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group;
wherein Ar₃ is selected from the group comprising: 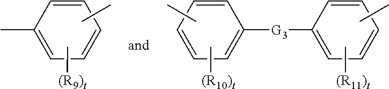
wherein t=0 to 3, wherein R₉, R₁₀, R₁₁ are selected from the group comprising hydrogen, halogen, alkyl, substituted alkyl, nitro, cyano, thioalkyl, alkoxy, substituted alkoxy, aryl, substituted aryl, alkyl ester, substituted alkyl ester, and combinations thereof,
wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group.

10. The solution according to claim 9, wherein x varies from 90 to 99 mole % of the repeat structure (I), and y varies from 1 to 10 mole % of the repeat structure (II).

11. The solution according to claim 1, wherein the solvent is a polar solvent or a mixed solvent comprising one or more polar solvents.

12. The solution according to claim 1, wherein the solvent is selected from the group consisting of methanol, ethanol, propanol, isopropanol (IPA), butanol, acetone, methyl ethyl ketone (MEK), methyl isobutyl ketone (MIBK), toluene, cresol, xylene, propylene glycol monomethyl ether acetate (PGMEA), N,N-dimethylacetamide (DMAc), N-methyl-2-pyrrolidinone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-Butoxy-N,N-dimethylpropanamide, 1-Ethyl-2-pyrrolidone, N,N-Dimethylpropionamide, N,N-Dimethylbutyramide, N,N-Diethylacetamide, N,N-Diethylpropionamide, 1-Methyl-2-Piperidinone, Propylene carbonate, a combination thereof, and a mixed solvent comprising at least one of the solvents.

13. A laminated composite material, comprising a base, and a polyamide resin layer;
wherein the polyamide resin layer is laminated to one surface of the base;
wherein the polyamide resin layer is obtained or obtainable by applying a polyamide solution comprising an aromatic polyamide, an inorganic filler and a solvent onto the base.

14. The laminated composite material according to claim 13, wherein the base or the surface of the base is composed of glass or silicon wafer.

15. The laminated composite material according to claim 13, wherein the material of the inorganic filler is selected from the group consisting of metal oxide, mineral, glass, or a mixture with constituents thereof.

16. The laminated composite material according to claim 15, wherein the inorganic filler is in the form of fibers or particles.

17. The laminated composite material according to claim 13, wherein retardation at 400 nm of thickness direction of the polyamide resin layer is 200 nm or less.

18. The laminated composite material according to claim 13, wherein coefficient of thermal expansion (CTE) of the polyamide resin layer is 40 ppm/K or less.

19. A process for manufacturing a display element, an optical element or an illumination element, comprising the steps of:
a) casting a solution of an aromatic polyamide into a film onto a base; and
b) forming the display element, the optical element or the illumination element on the surface of the polyamide film;
wherein the solution of an aromatic polyamide comprising an aromatic polyamide, a solvent, and an inorganic filler,
wherein the base or the surface of the base is composed of glass or silicon wafer.
